(19) United States
(12) Patent Application Publication
(10) Pub. No.: US 2026/0092555 A1
(43) Pub. Date: Apr. 2, 2026

(54) ENGINE SYSTEM AND A CHARGE AIR SYSTEM

(71) Applicant: CUMMINS INC., Columbus, IN (US)

(72) Inventor: Scott Robert Bardakjy, Columbus, IN (US)

(73) Assignee: CUMMINS INC., Columbus, IN (US)

(21) Appl. No.: 19/303,602

(22) Filed: Aug. 19, 2025

(30) Foreign Application Priority Data
Sep. 30, 2024 (IN) 202441073667

(51) Int. Cl. F02B 37/013; F02B 29/04

(52) U.S. Cl. CPC F02B 37/013; F02B 29/0406

(57) ABSTRACT

An engine system includes an engine that includes a cylinder head, an intake air manifold, and an exhaust manifold each coupled to the cylinder head. The engine system includes an intercooler coupled to the engine and positioned adjacent to the exhaust manifold. The engine system includes a first turbocharger on a first side of the engine in intake air providing communication in a first direction with the intercooler. The engine system includes a second turbocharger on a second side of the engine opposite the first side and is in exhaust gas receiving communication with the exhaust manifold and in intake air receiving communication in a second direction with the intercooler and is in intake air providing communication in a third direction with the intake air manifold. The second direction is substantially opposite the first direction.

### CROSS-REFERENCE TO RELATED APPLICATIONS

The present application claims priority to Indian Provisional Patent Application No. 202441073667, filed Sep. 30, 2024 and the contents of which are incorporated herein by reference.

### TECHNICAL FIELD

The present application relates generally to engine systems.

### BACKGROUND

Engine systems require large amounts of air to meet torque demands. The use of turbochargers increases the charge density of the air provided to the engine to achieve these torque demands.

### SUMMARY

According to one embodiment, an engine system including an engine. The engine includes a cylinder head, and an intake air manifold and an exhaust manifold each coupled to the cylinder head. The engine system also includes an intercooler coupled to the engine and positioned adjacent to the exhaust manifold. The engine system also includes a first turbocharger in intake air providing communication in a first direction with the intercooler. The engine system also includes a second turbocharger in exhaust gas receiving communication with the exhaust manifold. The second turbocharger is in intake air receiving communication in a second direction with the intercooler. The second turbocharger is in intake air providing communication in a third direction with the intake air manifold. The second direction is substantially opposite the first direction and the third direction extends in a direction substantially parallel to a length of the intercooler.

According to another embodiment, a charge air system includes a first turbocharger configured to couple to an engine. The first turbocharger comprising a first compressor and a first turbine. The charge air system also includes a second turbocharger configured to couple to the engine. The second turbocharger includes a second compressor and a second turbine. The charge air system also includes an intercooler configured to couple to the engine. The charge air system also includes a first conduit defining a first length and possessing a first curvature along a direction of flow through the first conduit. The first conduit fluidly coupling the first compressor and the intercooler. The charge air system also includes a second conduit defining a second length greater than the first length and possessing a second curvature and a third curvature along a direction of flow through the second conduit. The second conduit fluidly coupling the intercooler to the second compressor. The charge air system also includes a third conduit defining a third length. The third conduit configured to provide exhaust from the second turbocharger to the first turbocharger. The third length less than the first length.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a schematic diagram of an engine system according to one embodiment;

FIG. 2 is a side view of an engine system according to another embodiment; and

FIG. 3 is a schematic diagram of a portion of a first turbocharger and a portion of a second turbocharger of a charge air system for the engine system of FIG. 2 according to one embodiment.

FIG. 4 is a top view of the engine system of FIG. 2.

FIG. 5 is a top view of an engine system according to another embodiment.

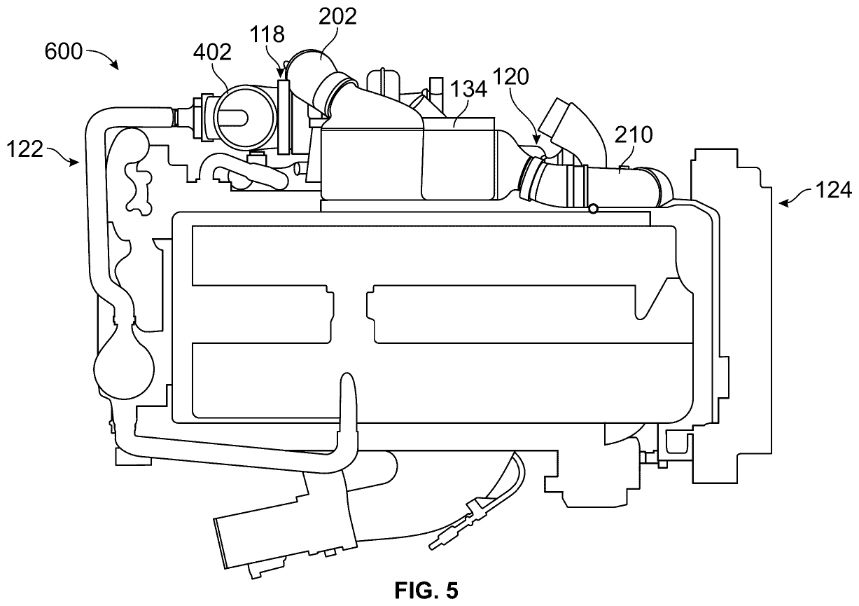

FIG. 6 is a side view of the engine system of FIG. 5.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, and apparatuses, of an engine system. The various concepts introduced above and discussed in greater detail below may be implemented in any of a number of ways, as the described concepts are not limited to any particular manner of implementation. Examples of specific implementations and applications are provided primarily for illustrative purposes.

Internal combustion (IC) engine systems (e.g., hydrogen IC engine systems, etc.) require a large volume of air (e.g., oxygen, etc.) for combustion in order to meet torque demands. By providing compressed air (e.g., charged air, etc.) to the engine, torque (e.g., power output, etc.) provided by the engine is increased.

Implementations herein relate to an engine system including a first turbocharger, an intercooler, and a second turbocharger. The first turbocharger is fluidly coupled to the intercooler, and the intercooler is fluidly coupled to the second turbocharger. The intercooler reduces (e.g., cools, etc.) the charged air from the first turbocharger before providing the compressed air to the second turbocharger. The second turbocharger receives the cooled compressed air and compressed and mixes the cooled compressed air with additional compressed air. According to implementations herein, the engine system is configured such that the length of each conduit between each of the first turbocharger, the intercooler, and the second turbocharger are minimized or reduced in length such that curvatures of the conduits possess an angle that facilitates maintaining a pressure of the flow through the engine system (e.g., minimizes pressure drop, reduces pressure drop, etc.).

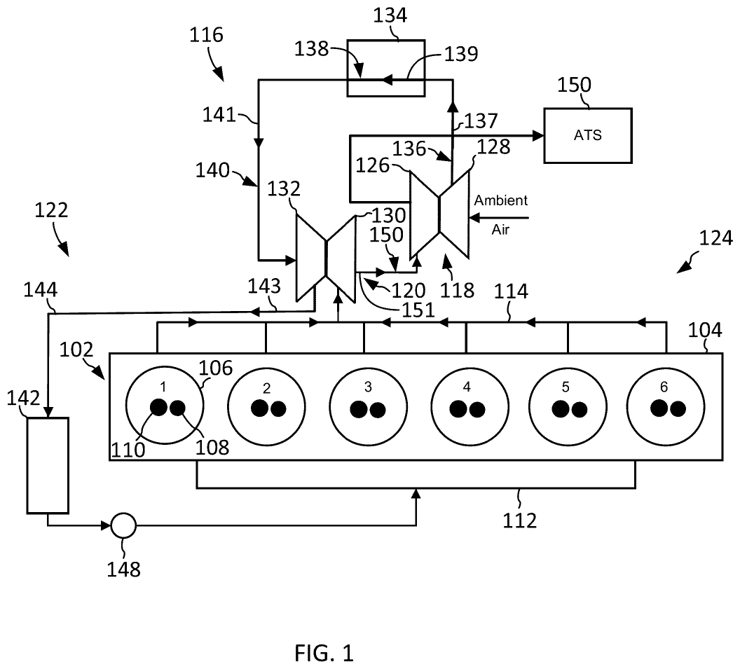

FIG. 1 is a schematic diagram of an engine system 100 according to an embodiment. According to this embodiment, the engine system 100 is an internal combustion engine system.

The engine system 100 includes an engine 102. The engine 102 includes a cylinder head 104. The engine 102 also includes an intake manifold 112 and an exhaust manifold 114 each coupled to the cylinder head 104. The engine system 100 also includes an intercooler 134 coupled to the engine 102 and positioned adjacent to the exhaust manifold 114. The engine system 100 also includes a first turbocharger 118 positioned on a first side 122 of the engine 102. The first turbocharger 118 is in intake air providing communication in a first direction 137 with the intercooler 134. The engine system 100 also includes a second turbocharger 120 positioned on a second side 124 of the engine 102 substantially opposite the first side 122. The second turbocharger 120 is in exhaust gas receiving communication with the exhaust manifold 114. The second turbocharger 120 is in intake air receiving communication in a second direction 141 with the intercooler 134. The second turbocharger 120 is in intake air providing communication in a third direction 151 with the intake air manifold 112. The second direction 141 is substantially opposite the first direction 137.

The engine 102 includes a cylinder head 104. The cylinder head 104 is configured to support various components of the engine 102. The engine 102 includes a plurality of cylinders 106 positioned within the cylinder head 104. Each of the plurality of cylinders 106 includes a fuel injector 108 and a spark plug 110. The fuel injector 108 is configured to provide (e.g., dose, inject, etc.) an amount of fuel (e.g., hydrogen, etc.) into one of the cylinders 106. The spark plug 110 is configured to provide energy (e.g., a spark, etc.) to ignite combustion of the fuel provided by the fuel injector 108 and the air (e.g., provided via an intake manifold, etc.) within each of the cylinders 106.

The engine 102 also includes the intake manifold 112 and the exhaust manifold 114. Each of the intake manifold 112 and the exhaust manifold 114 are coupled to the cylinder head 104. The intake manifold 112 is configured to receive air (e.g., ambient air, etc.) from an air intake system of the engine. The intake manifold 112 is in intake air providing communication with the plurality of cylinders 106. For example, the intake manifold 112 is configured to provide (e.g., deliver, etc.) intake air (e.g., ambient air, etc.) to the plurality of cylinders 106 for use in combustion.

The exhaust manifold 114 is in exhaust gas receiving communication with the plurality of cylinders 106. For example, the exhaust manifold 114 is configured to receive exhaust gas from the cylinders 106 after combustion occurs.

The engine system 100 also includes a charge air system 116. The charge air system 116 includes the first turbocharger 118 configured to couple to the engine 102. The first turbocharger 118 includes a first compressor 128 and a first turbine 126. The charge air system 116 also includes a second turbocharger 120 configured to couple to the engine 102. The second turbocharger 120 includes a second compressor 132 and a second turbine 130. The charge air system 116 also includes an intercooler 134 configured to couple to the engine 102. The charge air system 116 also includes a first conduit 202 defining a first length L₁ and possessing a first curvature 208 along a direction of flow through the first conduit 202. The first conduit 202 fluidly coupling the first compressor 128 and the intercooler 134. The charge air system 116 also includes a second conduit 210 defining a second length L₂ greater than the first length L₁ and possessing a second curvature 216 along a direction of flow through the second conduit 210. The second conduit 210 fluidly coupling the intercooler 134 to the second compressor 132. The charge air system 116 also includes a third conduit 224 defining a third length L₃. The third conduit 224 is configured to provide exhaust from the second turbocharger 120 to the first turbocharger 118. The third length L₃ is less than the first length L₁.

The engine system 100 includes the first turbocharger 118 and the second turbocharger 120. According to this embodiment, the first turbocharger 118 is positioned on a first side 122 of the engine 102 (e.g., a front side, a front half of the engine 102, etc.) and the second turbocharger 120 is positioned on a second side 124 of the engine 102 (e.g., a rear half, a rear side, a side opposite the first turbocharger 118, etc.). Each of the first turbocharger 118 and the second turbocharger 120 can be a variable geometry turbocharger (VGT) or a wastegate (WG) turbocharger. The first turbocharger 118 may be a low-pressure turbocharger, and the second turbocharger 120 may be a high-pressure turbocharger.

Each of first turbocharger 118 and the second turbocharger 120 are configured to compress air (e.g., compress ambient air from the intake air system, etc.) and provide the compressed air to the engine 102 (e.g., via the intake manifold 112, etc.).

The first turbocharger 118 includes the first turbine 126 and the first compressor 128. According to this embodiment, the first turbine 126 and the first compressor 128 are mounted on a common shaft (e.g., axially aligned on a first common shaft, etc.). For example, the first turbine 126 and the first compressor 128 rotate about the same shaft at about the same speed.

Similarly, the second turbocharger includes the second turbine 130 and the second compressor 132. According to this embodiment, the second turbine 130 and the second compressor 132 are mounted on a common shaft (e.g., axially aligned on a second common shaft, etc.) such that the second turbine 130 and the second compressor 132 rotate about the same shaft at about the same speed. For example, the second turbine 130 and the second compressor 132 can be mounted on a second common shaft offset from the first turbine 126 and the first compressor 128 mounted on the first common shaft.

The engine system 100 also includes the intercooler 134 (e.g., a charge air cooler, etc.). The intercooler 134 is coupled to the engine 102 above (e.g., vertically offset from, etc.) the exhaust manifold 114. For example, the intercooler 134 is coupled to the cylinder head 104 above (e.g., a distance vertically away from, etc.) the exhaust manifold 114. The intercooler 134 is in fluid receiving communication with the first turbocharger 118 (e.g., compressed intake air receiving communication, etc.). According to this embodiment, the intercooler 134 is positioned at or substantially near a center of a longitudinal axis A_{L} of the engine 102. For example, the intercooler 134 is positioned along a longitudinal axis A_{L} of the engine 102 substantially between the first turbocharger 118 and the second turbocharger 120. The intercooler 134 is structured to cool intake air flowing therethrough to increase charge density of the air. Increasing the charge density of the air increases the power output of the engine 102.

The first compressor 128 includes a plurality of first compressor blades. The first compressor blades are positioned within the first compressor 128 (e.g., within a compressor housing, within a compressor body, etc.). The first compressor blades are coupled to the shaft (e.g., the common shaft, etc.) and rotate about the shaft. The blades comprise varying size and shape to compress intake air (e.g., ambient air, etc.) provided to the first compressor 128.

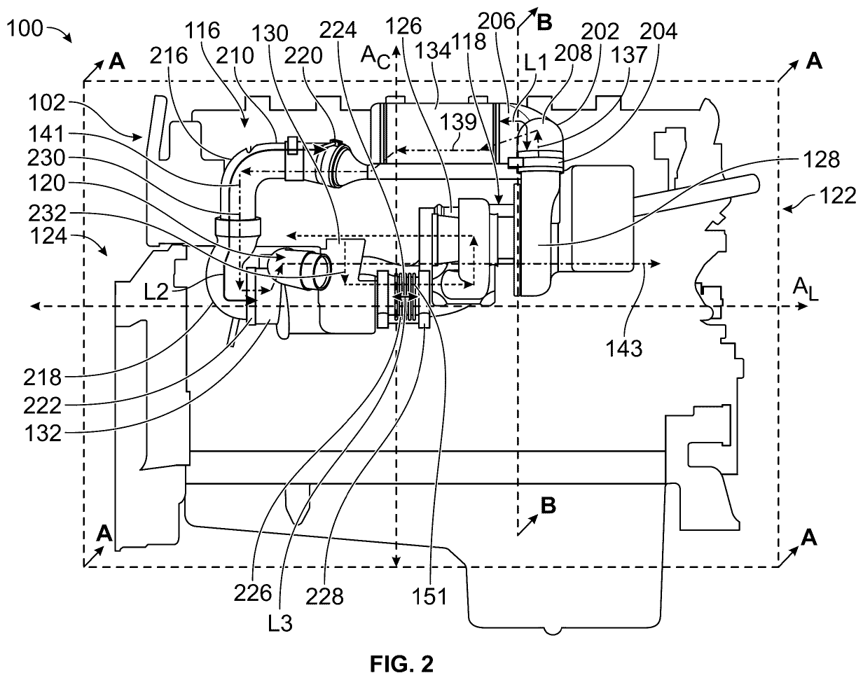

The first compressor 128 receives filtered intake air (e.g., from an intake system, etc.) and compresses the intake air to increase its charge density. The first compressor 128 is configured to provide the compressed intake air to the intercooler 134. For example, the first compressor 128 is in intake air providing communication with the intercooler 134 (e.g., compressed air providing communication, the intercooler 134 is in intake air receiving communication with the first compressor 128, etc.). As shown in FIGS. 1 and 2, the first compressor 128 provides compressed intake air to the intercooler 134 along a first flow path 136 extending in at least a first direction 137, such that flow is provided to the intercooler 134 in the first direction 137 as described in more detail below.

The intercooler 134 is in intake air receiving communication with the first compressor 128 of the first turbocharger 118. As shown in FIGS. 1 and 2, the intake air provided by the first compressor 128 flows through the intercooler 134 along an intercooler flow path 138 extending in an intercooler direction 139. According to this embodiment, the intercooler flow path 138 is positioned at an angle relative to the first flow path 136. For example, the intercooler flow path 138 flows through the intercooler 134 and is substantially perpendicular to the first flow path 136. Flow through the intercooler 134 in the intercooler direction 139 substantially perpendicular to the first direction 137.

The intercooler 134 is in intake air providing communication with the second compressor 132 of the second turbocharger 120. The intercooler 134 provides the cooled compressed intake air to the second compressor 132. For example, the intercooler 134 provides the cooled compressed intake air to the second compressor 132 along a second flow path 140. The second flow path 140 extends in a second direction 141. The second flow path 140 provides flow in a direction (e.g., the second direction 141, etc.) opposite the direction of flow within the first flow path 136 (e.g., the first direction 137, etc.). For example, the second flow path 140 flows in the second direction 141 that is substantially parallel to the first flow path 136 that flows in the first direction 137 and substantially perpendicular to the intercooler flow path 138 that flows in the intercooler direction 139.

The second compressor 132 includes a plurality of second compressor blades. The second compressor blades are positioned within the second compressor 132 (e.g., within a compressor housing, within a compressor body, etc.). The second compressor blades are coupled to the shaft (e.g., the common shaft, etc.) and rotate about the shaft. The blades comprise varying size and shape to compress intake air (e.g., ambient air, etc.) provided to the second compressor 132.

The second compressor 132 is configured to provide the cooled compressed intake air from the intercooler 134 to the intake manifold 112 in a third direction 143. For example, the second compressor 132 is in intake air providing communication with the intake manifold 112 in the third direction 143. The third direction 143 is substantially parallel to the intercooler direction 139.

The second turbine 130 is in exhaust gas receiving communication with the exhaust manifold 114. The exhaust gas received from the exhaust manifold 114 causes (e.g., facilitates, etc.) rotation of the second turbine 130, which causes (e.g., facilitates, drives, etc.) rotation of the second compressor 132.

The second turbine 130 is in exhaust gas providing communication with the first turbine 126 of the first turbocharger 118. For example, the first turbine 126 receives exhaust gas from the second turbine 130 causing (e.g., facilitates, etc.) rotation of the first turbine 126, which causes (e.g., facilitates, drives, etc.) rotation of the first compressor 128.

According to this embodiment, the engine system 100 also includes a charge air cooler 142. The charge air cooler 142 is positioned along an intake air flow path 144 downstream of the second turbocharger 120. The charge air cooler 142 is in compressed intake air receiving communication with the second compressor 132 of the second turbocharger 120. The charge air cooler 142 is configured to cool the compressed intake air increasing the charge density of the compressed intake air.

The engine system 100 also includes an air intake throttle 148. The air intake throttle 148 is positioned along the intake air flow path 144 downstream of the charge air cooler 142 and upstream of the intake manifold 112. The air intake throttle 148 is configured to provide an amount (e.g., dose, etc.) of compressed intake air to the intake manifold 112.

As shown in FIGS. 1 and 2, the second turbine 130 provides exhaust gas to the first turbine 126 along a third flow path 150. The third flow path 150 extends along a fourth direction 151 that is substantially parallel to the intercooler flow path 138 and substantially perpendicular to the first flow path 136 and the second flow path 140. As discussed in more detail below, the second turbocharger 120 is positioned such that a distance (e.g., a third distance, etc.) of the third flow path 150 between the first turbocharger 118 and the first turbocharger 118 is minimized or reduced (e.g., shortened, less than the first flow path, less than the intercooler flow path, less than the second flow path, etc.).

The engine system 100 also includes an aftertreatment system 152. The aftertreatment system 152 is positioned on the second side 124 (e.g., a rear half, a rear side, a side opposite the first side 122, etc.) of the engine 102. The aftertreatment system 152 is in fluid receiving communication with the first turbine 126 (e.g., exhaust gas receiving communication with, etc.). The first turbine 126 receives exhaust from the second turbine 130 and provides the exhaust to the aftertreatment system 152. The aftertreatment system 152 is configured to treat the exhaust gas. For example, the aftertreatment system 152 is configured to provide (e.g., dose, inject, etc.) reductant and mix the reductant with the exhaust. In some embodiments, the engine system 100 can include an exhaust gas recirculation (EGR) system configured to recirculate a portion of treated exhaust back to the engine 102.

Now referring to FIG. 2, a side view of an example of the engine system 100 including the charge air system 116 is shown. As shown in FIG. 2, the engine system 100 also includes the first conduit 202. The first conduit 202 is coupled to an outlet 204 of the first compressor 128 and an inlet 206 of the intercooler 134. The first conduit 202 defines a first length (e.g., shown as L_{1A}, and L_{1B}, a flow path first length, etc.) along a direction of flow. For example, the first conduit 202 extends the first length L_{1A} and L_{1B} between the outlet 204 of the first compressor 128 and an inlet 206 of the intercooler 134. The first conduit 202 provides compressed intake air from the first turbocharger 118 along the first flow path 136 to the intercooler 134.

The first conduit 202 has (e.g., possesses, etc.) the first curvature 208. The first curvature 208 redirects flow at an angle along the direction of flow through the first conduit 202 from the first compressor 128 to the intercooler 134. For example, intake air flows out of the first compressor 128 outlet 204 in a first compressor outlet direction (e.g., a vertical direction, a direction substantially perpendicular to the longitudinal direction of the engine 102, etc.). Flow exiting the outlet 204 of the first compressor 128 is then redirected through the first curvature 208 (e.g., at redirected along an axis substantially perpendicular to the first compressor outlet direction, etc.) and into the intercooler 134. For example, flow enters the first curvature 208 (e.g., flowing in the first compressor outlet direction, etc.) and is redirected at an angle (e.g., about 90 degrees, etc.) to an intercooler direction. For example, the is the angle between the first compressor outlet direction and the intercooler inlet direction can be substantially perpendicular relative to a longitudinal cross-sectional view of the engine 102 (e.g., along plane A-A, etc.). According to the embodiment shown in FIG. 2, the first compressor outlet direction is also substantially perpendicular to the intercooler inlet direction along a lateral cross-sectional view of the engine 102 (e.g., along plane B-B, etc.).

The engine system 100 also includes the second conduit 210. The second conduit 210 fluidly couples the intercooler 134 and the second turbocharger 120. For example, the second conduit 210 defines a second length L₂ along the second flow path 140. A first end of the second conduit 210 is coupled to an outlet 212 of the intercooler 134 (e.g., an outlet 212 of the intercooler 134, etc.) and a second end of the second conduit 210 is coupled to an inlet of the second compressor 132 of the second turbocharger 120.

The second conduit 210 has (e.g., possess, defines, etc.) the second curvature 216. According to this embodiment., the second conduit 210 also includes a third curvature 218. For example, as shown in FIG. 2, the third curvature 218 of the second conduit 210 is positioned downstream of the second curvature 216. The second curvature 216 redirects flow at a second angle (e.g., in various embodiments between 85 degrees and about 95 degrees, about a 90-degree angle, etc.) along the direction of flow (e.g., along the second length L₂, along the second flow path 140, etc.). Similarly. The third curvature 218 directs flow at a third angle (e.g., in various embodiments between 85 degrees and about 95 degrees, about a 90-degree angle, substantially perpendicular to, etc.) to an inlet of the second turbocharger 120. For example, flow (e.g., compressed intake air, etc.) exiting the intercooler 134 flows along the intercooler direction through the second curvature 216 and is then directed at the second angle (e.g., directed at an angle ranging from 85 degrees to 95 degrees relative to the intercooler direction, a 90-degree angle relative to the intercooler direction, etc.) and then directed at the third angle (e.g., in various embodiments between 85 degrees and about 95 degrees, a 90-degree angle, etc.) to the second compressor 132 of the second turbocharger 120. For example, flow entering the second compressor 132 flows in a direction opposite the direction of flow exiting the intercooler 134. As shown in FIG. 2, the second curvature 216 directs flow received from an outlet 220 of the intercooler 134 at the second angle (e.g., in various embodiments between 85 degrees and about 95 degrees, substantially perpendicular, etc.) and directs flow at the third angle into an inlet 222 of the second compressor 132 when view along a longitudinal cross-sectional view (e.g., along plane A-A, etc.).

The engine system 100 also includes the third conduit 224. As previously described, the second turbine 130 is in exhaust gas receiving communication with the exhaust manifold 114. The second turbine 130 is also in exhaust gas providing communication with the first turbine 126. The third conduit 224 fluidly couples the second turbine 130 of the second turbocharger 120 to the first turbine 126 of the first turbocharger 118. For example, a first end of the third conduit 224 is coupled to an outlet 226 of the second turbine 130 and a second end of the third conduit 224 is coupled to an inlet 228 of the first turbine 126.

As shown in FIG. 2, the second turbine 130 is positioned on the first side 122 of the engine 102 such that the outlet 226 of the second turbine 130 is adjacent to (e.g., a distance away from, etc.) a central axis A_{C} (e.g., a vertical central axis, a vertical central axis defining the first side 122 and the second side 124, an axis substantially perpendicular to the longitudinal axis A_{L}, etc.) of the engine 102. Similarly, the first turbine 126 is positioned on a second side 124 of the engine 102 such that an inlet 228 of the first turbine 126 is adjacent to the central axis A_{C} of the engine 102. As such, the third conduit 224 has a third conduit length L₃ (e.g., defines, etc.) that is minimized or reduced. For example, the third conduit length L₃ is reduced such that the pressure of the exhaust gas provided to the first turbine 126 is maintained (e.g., the pressure drop between the second turbine 130 and the first turbine 126 is minimized or reduced, etc.).

As shown in FIGS. 1 and 2, the third conduit length L₃ is less than each of the first conduit length L₁ and the second conduit length L₂. The first conduit length L₁ is also less than the second conduit length L₂. According to this embodiment, the first conduit length L₁ is also greater than (e.g., longer than, etc.) the third conduit length L₃. For example, the distance between the first compressor 128 of the first turbocharger 118 and the intercooler 134 is minimized (e.g., reduced, shortened, etc.) By minimizing or reducing the lengths of each of the first conduit 202, the second conduit 210, and the third conduit 224, compressed intake air pressure is maintained (e.g., pressure drop of the compressed air intake is minimized or reduced, etc.). Similarly, by directing flow through simplistic bends (e.g., right angles, substantially 90-degree angles, etc.) of each of the first curvature 208 and the second curvature 216, pressure of the compressed intake air providing to the second compressor 132 and subsequently to the intake manifold 112 is maintained. Maintaining high pressure (e.g., higher or increased pressure, a desired pressure, etc.) within the engine system 100 maintains engine output and performance.

FIG. 2 also illustrates an intake air flow path 230 and an exhaust flow path 232 for the engine system. The intake air flow path 230 begins approximately at the outlet 204 of the first turbocharger 128. The first turbocharger 128 provides flow in a direction towards a top side of the engine system 100 and into the intercooler 134. The intercooler 134 directs flow in a longitudinal direction from the first side 122 towards the second side 124. The second conduit 210 directs the intake sir flow path 230 towards a bottom side of the engine system 100 and into an inlet 22 of the second compressor 132. The second compressor 132 then directs the intake air flow 230 towards the first side 122 of the engine system 100 providing the intake air to the intake manifold 112.

The intake air flow path 230 flows in a counterclockwise direction through the engine system 100. For example, the intake air flow path 230 flows from the first compressor 128 to the intercooler 134 in a direction substantially perpendicular to the longitudinal axis A_{L} via the first conduit 202 (e.g., in a direction from a bottom side of the engine system 100 to a top side opposite the bottom side of the engine system 100, etc.). The intake air flow path 230 then flows through the intercooler 134 and the intercooler 134 provides flow to the second conduit 210 in a direction substantially parallel to the longitudinal axis A_{L} (e.g., from the first side 122 to the second side 124, etc.). Within the second conduit 210, the intake air flow 230 flows in a direction substantially perpendicular to the longitudinal axis A_{L} (e.g., in a direction from the top side of the engine system 100 to the bottom side of the engine system 100, etc.) and then flows in a direction substantially parallel to the longitudinal axis A_{L} (e.g., in a direction from the second side 124 towards the first side 122, etc.) into the second compressor 132. The intake air flow path 230 then flows through the second compressor 132 and to the intake manifold 112.

The exhaust flow path 232 also flows in a counterclockwise direction. For example, the second turbine 130 receives exhaust from the exhaust manifold 114 in a direction substantially perpendicular to the longitudinal axis A_{L} (e.g., in a direction from the top side of the engine system 100 towards the bottom side of the engine system 100, etc.). The exhaust flow path 232 flows in the second turbine 130 towards the bottom side of the engine 100. The exhaust flow path 232 then flows through the outlet 226 of the second turbine 130 in a direction substantially parallel to the longitudinal axis A_{L} through the third conduit 224 (e.g., in a direction from the second side 124 of the engine system 100 towards the first side 124, etc.) and into the inlet 228 of the first turbine 126. The exhaust flow path 232 then flows through the first turbine 126 and in a direction substantially parallel to the longitudinal axis A_{L} (e.g., in a direction from the first side 122 of the engine system 100 towards the second side 124 of the engine system 100, etc.).

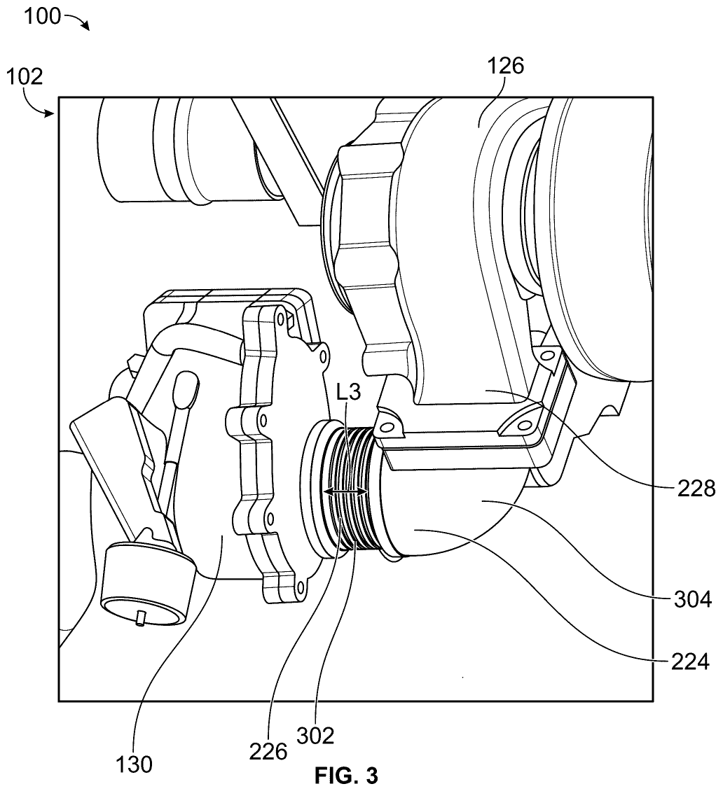

Now referring to FIG. 3, a portion of the engine system 100 including the third conduit 224 is shown. The third conduit 224 can include a flexible portion 302 and a fourth curvature 304. The flexible portion 302 is configured to bend (e.g., deform, etc.) to facilitate alignment of a first end of the third conduit 224 with the outlet of the second turbine 130 and a second end of the third conduit 224 with an inlet of the first turbine 126.

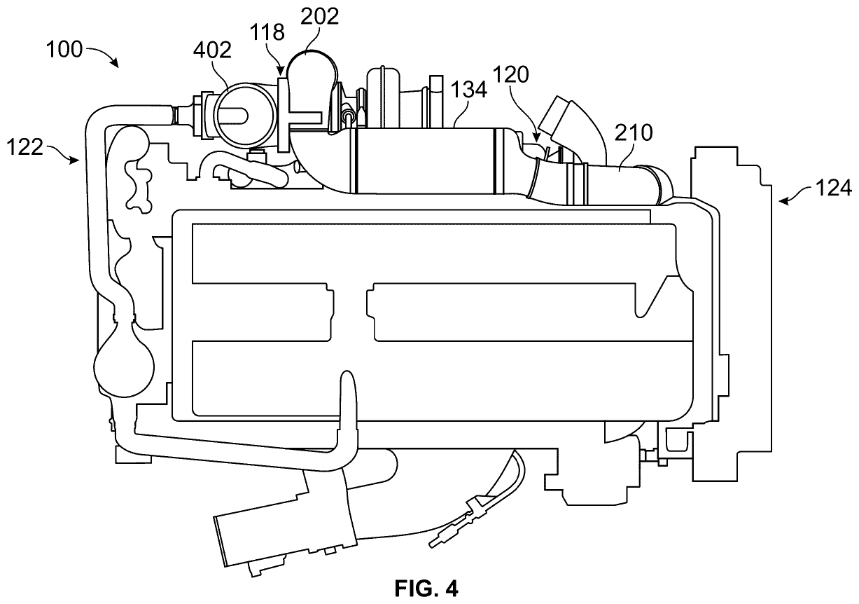

FIG. 4 is top view of the engine system 100. As shown in FIG. 4, the engine system 100 includes an intake air system 402. The first compressor 128 receives air from the intake air system 402 (e.g., is in intake air receiving communication with, etc.). The intake air system 402 is configured to draw ambient air into the engine system 100.

The first conduit 202 is in compressed air providing communication with the intercooler 134. As shown in FIG. 4, the second conduit 202 provides the compressed air to the intercooler 134 in the first direction 137. As such, flow in the second conduit flows from a lateral side of the engine system 100 towards the longitudinal axis A_{L} For example, flow exits the first compressor 128 in an exit direction that is substantially perpendicular to the first direction 137. Flow is then directed through the intercooler 134 in a direction substantially parallel to the longitudinal axis A_{L}.

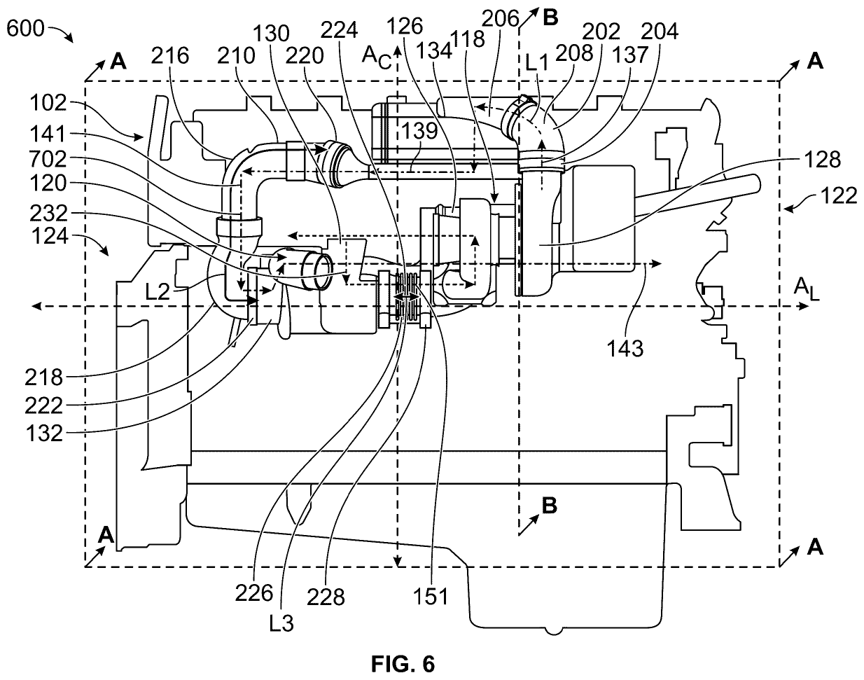

FIGS. 6 and 7 illustrate the engine system 600 according to another embodiment. According to this embodiment, the first conduit 202 directs the intake air flow path 602 towards the longitudinal axis A_{L} at an angle, and more particularly at a non-perpendicular angle, relative to the longitudinal axis A_{L} as shown in FIG. 6. As shown in FIG. 7, the intake air flow path 602 flows in a substantially counterclockwise direction. According to this embodiment, the first conduit 202 provides the intake air to the intercooler 134, and once inside the intercooler 134, the intake air flow path 602 is directed in a direction substantially perpendicular to the longitudinal axis A_{L} towards the bottom of the engine system 100 (e.g., from the top side of the engine system 100 towards the bottom side, downward, etc.). Once in the intercooler 134, the intake air flow path 602 flows in a direction substantially perpendicular to the longitudinal axis A_{L} towards the second end 124 of the engine system similar to the embodiment of FIG. 2.

While this specification contains many specific implementation details, these should not be construed as limitations on the scope of what may be claimed but rather as descriptions of features specific to implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a sub combination or variation of a sub combination.

The term “coupled” and the like, as used herein, mean the joining of two components directly or indirectly to one another. Such joining may be stationary (e.g., two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is

1. An engine system comprising:
an engine comprising:
a cylinder head; and
an intake air manifold and an exhaust manifold each coupled to the cylinder head;
an intercooler coupled to the engine and positioned adjacent to the exhaust manifold;
a first turbocharger in intake air providing communication in a first direction with the intercooler; and
a second turbocharger in exhaust gas receiving communication with the exhaust manifold, the second turbocharger in intake air receiving communication in a second direction with the intercooler, the second turbocharger in intake air providing communication in a third direction with the intake air manifold, the second direction substantially opposite the first direction.

2. The engine system of claim 1, wherein the third direction extends in a direction substantially parallel to a length of the intercooler.

3. The engine system of claim 1, wherein the first turbocharger is a low-pressure turbocharger, and the second turbocharger is a high-pressure turbocharger.

4. The engine system of claim 1, wherein the second turbocharger is in exhaust gas providing communication with the first turbocharger.

5. The engine system of claim 4, further comprising an aftertreatment system in exhaust gas receiving communication with the first turbocharger.

6. The engine system of claim 1, wherein the intercooler is centered along a length of the engine.

7. The engine system of claim 1, wherein the intercooler is positioned such that intake air passes through the intercooler in an intercooler direction substantially parallel to the first direction.

8. The engine system of claim 7, wherein the third direction is substantially parallel to the intercooler direction.

9. The engine system of claim 1, further comprising a charge air cooler in compressed intake air receiving communication with a compressor of the second turbocharger and in compressed intake air providing communication with the intake manifold.

10. The engine system of claim 1, wherein the first turbocharger in exhaust gas receiving communication with the second turbocharger along a fourth direction substantially perpendicular to the first direction and the second direction.

11. The engine system of claim 1, wherein intake air flows from the first turbocharger to the intercooler in a direction substantially perpendicular to a longitudinal axis of the engine.

12. The engine system of claim 11, wherein the intake air flows from the intercooler to the second turbocharger in a direction substantially perpendicular to the longitudinal axis of the engine, followed by a direction substantially parallel to the longitudinal axis of the engine.

13. The engine system of claim 12, wherein exhaust gas flows from the exhaust manifold to the second turbocharger in a directly substantially perpendicular to the longitudinal axis of the engine.

14. The engine system of claim 13, wherein the exhaust gas flows from the second turbocharger to the first turbocharger in a direction substantially parallel to the longitudinal axis of the engine.

15. The engine system of claim 1, further comprising a first conduit fluidly coupling the first turbocharger and the intercooler, the first conduit defining a first length and possessing a first curvature along a direction of flow through the first conduit.

16. The engine system of claim 15, further comprising a second conduit fluidly coupling the intercooler to the second turbocharger, the second conduit defining a second length greater than the first length.

17. The engine system of claim 16, further comprising a third conduit coupling the second turbocharger to the first turbocharger, the third conduit defining a third length less than the first length.

18. A charge air system comprising:
a first turbocharger configured to couple to an engine, the first turbocharger comprising a first compressor and a first turbine;
a second turbocharger configured to couple to the engine, the second turbocharger comprising a second compressor and a second turbine;
an intercooler configured to couple to the engine;
a first conduit defining a first length and possessing a first curvature along a direction of flow through the first conduit, the first conduit fluidly coupling the first compressor and the intercooler;
a second conduit defining a second length greater than the first length and possessing a second curvature and a third curvature along a direction of flow through the second conduit, the second conduit fluidly coupling the intercooler to the second compressor; and
a third conduit defining a third length, the third conduit configured to provide exhaust from the second turbocharger to the first turbocharger, the third length being less than the first length.

19. The charge air system of claim 18, wherein each of the first curvature, the second curvature, and the third curvature are configured to redirect flow at an angle, the angle being between 85 degrees and 95 degrees relative to a received flow path.

20. The charge air system of claim 18, wherein the direction of flow through the second conduit is substantially opposite to the direction of flow through the first conduit.
